(19) United States
(12) Patent Application Publication
(10) Pub. No.: US 2003/0120523 A1
(43) Pub. Date: Jun. 26, 2003

(54) Method, system and apparatus for managing multiple channels of travel services

(76) Inventors: Sajid Husain Jafri, Foster City, CA (US); Christopher John Hanson, Palo Alto, CA (US); Vajid Husain Jafri, Redwood Shores, CA (US); Vipin Kumar, Union City, CA (US)

Correspondence Address: ELLSWORTH R. ROSTON, ESQ., FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/027,477

(22) Filed: Dec. 21, 2001

(51) Int. Cl. G06F 17/60

(52) U.S. Cl. 705/5

(57) ABSTRACT

Legacy transactions, and their costs, meeting specified parameters may be provided through a wide area network to a processing station (e.g. a travel agency). These parameters may be airline flights leaving on a particular day from a specified originating location to a specified destination and specifying established and published fares of primary airlines. Individual transactions (e.g., airline flights and fares) may be provided to a database at the travel agency through the internet from (a) airlines other than the primary airlines in the legacy servers, (b) the primary airlines with discounted fares, (c) consolidators offering wholesale fares and (d) an Orbitz web server. A display screen at the processing station respectively displays the legacy transactions and the other transactions on first and second portions of a display screen. The database selects one of the transactions and provides for the printing of a ticket for the selected transaction at a printer at the travel agency or a printer at the legacy server and for an accounting at the travel agency or the legacy server.

A method of presenting offers of travel services is disclosed. The method may include providing a client computer having a human interface, inputting requests for details of travel services, sending requests to a global distribution system and to a server computer, translating the request into web requests, sending web requests to websites and receiving responses therefrom, and displaying responses from the websites and from the global distribution system on a single display screen. Software and hardware such as may be used for embodying the method are also disclosed.

This is a continuation-in-part application of application Ser. No. ______ filed on Dec. 5, 2001, for a METHOD, SOFTWARE PRODUCT, SYSTEM AND APPARATUS FOR MANAGING MULTIPLE CHANNELS OF TRAVEL SERVICES and listing Vajid Husain Jafri, Christopher Hohn Hanson, Vipin Kumar and Sajid Husain Jafri as joint inventors and assigned of record to the assignee of record of this application.

This invention relates to services and accounting within the retail and wholesale travel services industries. This invention further relates to a system and a method for gathering offers of travel services from each of multiple travel service suppliers and their agents.

### BACKGROUND OF A PREFERRED EMBODIMENT OF THE INVENTION

The primary airlines (e.g. American, United and Delta) have handled bookings for their flights on legacy servers which have been identified by the trademarks “Sabre®”, “Galileo®”, “Amadeus®” and “Worldspan®”. The primary airlines provide established and published flight schedules and fares for their flights in these legacy servers. The legacy servers transmit these airline flights and fares through a wide area network to processing stations (e.g. travel agencies). Travel agents at the travel agencies obtain flight and fare information for their clients at processing stations at the travel agencies. The travel agents receive commissions when they book flights through the legacy servers. However, recently the primary airlines providing flight and fare information to the legacy computers have reduced the amount of the commissions paid to travel agents when the travel agents book the flights.

A number of airlines are not in the legacy servers. They include Southwest Airlines and America West Airlines. Tickets on these airlines can be obtained by telephone calls either from the travel agent or the client. Furthermore, the airlines provide for purchasers of tickets on the internet through Orbitz®. Orbitz offers tickets at reduced prices. These reduced prices are below the established and published prices which are provided in the legacy servers of the primary carriers, but these discounts are generally only for flights in the near future and are often at the least desirable hours, such as late at night. Consolidators also purchase blocks of tickets from the airlines at wholesale prices and offer theses tickets through telephone lines to passengers generally at prices above the wholesale prices but below the retail price established and published by the airlines.

As will be seen from the above discussion, there are a number of different ways for a passenger to purchase airplane tickets. Some of these are at established and published retail prices. Others of these are at discounted prices. Some of these are available to travel agents and others are not. It would be desirable for travel agents to be accessible to all of these different ways of purchasing airline tickets. It would also be desirable for the travel agents to be able to offer to a client, with a minimal amount of effort, the optimal travel time for the client on a specified date at the lowest price on an airline acceptable to the client to travel from a specific originating location to a specific destination.

The following is the “Background” from the parent application:

The commercial sector of the Web has been extensively used for direct sales of travel services. At the consumer or end-user level, systems and methods for conducting e-commerce typically involve a computer running a web browser for accessing web pages from remote servers via the one and only, well-known, Internet. Computerized travel booking services, especially for air travel have become more complex with the rise in popularity of the Internet. Not only are there many more sources of services but terms and conditions are increasingly complex. A need to manage the various complexities on a single client computer exists. Sales and ancillary sales support activity (such as ticketing) within the travel industry is typified or dominated by an airline component. Thus the airline component services of the travel industry is paradigmatically used and envisioned in accompanying diagrams. A small number of online services provide a large proportion of air travel fares quotation and ordering for air travel booked by travel agents for clients. There are four such online services, they are known by their trade names, Sabre®, Worldspan®, Galileo®M, and Amadeus®. These are collectively and individually known, in the art, as GDS (global distribution system(s)).

An important reason that travel agents use GDS is that they provide familiar bookkeeping arrangements, credit, ticketing, refunds and other terms and conditions. Especially, GDS generate accounting records for computerized billing systems and reports including statistics for clients. Such report keeping is of great importance to business and corporate clients.

However, the Internet and World Wide Web (“the Web”) have become everyday utilities for many businesses and individuals and often provide cheaper tickets than are available through GDS's. Under price performance pressure travel agents scan the world wide web for better prices and then purchase tickets over the Internet. The travel agent must then typically enter the purchase into a GDS in order to generate the required accounting records. Often, too, a service charge (profit margin) must be charged separately, rather than a preferred method of bundling or commissions from the supplier. Another problem is that Internet sales can often have complex and unfamiliar terms and conditions with the risk that the agent may purchase a non-refundable fare only to later notice a restriction that makes the fare useless to the client. Since the terms are not presented in a standard way, they are open to misinterpretation. Also, the agent may need authorization to advance credit (usually credit card credit) for the purchase. This can result in a dilemma for the business owner as to how much authority to spend money should be given to the agent since each situation is unique. Thus, the Internet is not as travel agent friendly as the GDS. However, sometimes travel agents must use the Internet to access websites or lose business. Websites are well known in the art.

### BRIEF DESCRIPTION OF A PREFERRED EMBODIMENT OF THE INVENTION

Legacy transactions, and their costs, meeting specified parameters may be provided through a wide area network to a processing station (e.g. a travel agency). These parameters may be airline flights leaving on a particular day from a specified originating location to a specified destination and specifying established and published fares of primary airlines. Individual transactions (e.g., airline flights and fares) may be provided to a database at the travel agency through the Internet from (a) airlines other than the primary airlines in the legacy servers, (b) the primary airlines with discounted fares, (c) consolidators offering wholesale fares and (d) an Orbitz web server. A display screen at the processing station respectively displays the legacy transactions and the other transactions on first and second portions of a display screen. The database selects one of the transactions and provides for the printing of a ticket for the selected transaction at a printer at the processing station (e.g. travel agency) or a printer at the legacy server and for an accounting at the travel agency or legacy server.

The following constitutes the “Summary” of the invention from the parent application:

According to a first aspect of the invention, a method of presenting offers of travel services is disclosed. The method may include providing a client computer having a human interface, inputting requests for details of travel services, sending requests to a GDS and to a server computer, translating the request into web requests, sending web requests to websites and receiving responses therefrom, and displaying responses from the websites and from the GDS on a single display screen. According to a further aspect of the invention, software is provided to implement the method of the first aspect. According to a still further aspect of the invention, computers are provided to implement the method of the first aspect.

These and other features and advantages of the invention are set forth in part in the description which follows and in part will become apparent to those having ordinary skill in the art upon examination of the following or may be learned from practice of the invention. The advantages of the invention may be realized and attained as particularly pointed out in the appended claims. The embodiments described should be viewed as exemplary and enabling and disclosing best know mode rather than limiting as to the bounds of the invention.

### BRIEF DESCRIPTION OF THE DRAWINGS

In the drawings:

FIG. 1 shows a high level depiction of one embodiment of the invention;

FIG. 2 shows a high level depiction of a travel agency client computer network according to an embodiment of the invention;

FIG. 3 schematically represents a client computer used in an embodiment of the invention;

FIG. 4 schematically represents a server computer such as may be used to implement embodiments of the invention;

FIG. 5 shows a client computer display screen layout such as may be used in one embodiment of the invention;

FIG. 6 shows a flow diagram of reservation functions according to an embodiment of the invention;

FIG. 7 shows a flow diagram of accounting functions according to an embodiment of the invention;

FIG. 8 is a schematic diagram showing in block form a system of the prior art for providing air flight and air fare information for global distribution systems (Sabre®, Worldspan®, Galileo®, and Amadeus®), major hotel chains and major car rental companies;

FIG. 9 is a schematic diagram showing in block form a system of the prior art for providing air flight and air fares for the airlines other than those shown in FIG. 7, for the car rental agencies other than those shown in FIG. 7, for the wholesale inventory of the airlines and for tour operators;

FIG. 10 is a schematic diagram showing in block form a system constituting a preferred embodiment of applicants' invention (but claimed by applicants in another patent application) and providing for information relating to flight and fare information from the airlines, hotel chains, car rental companies and cruise line companies to be provided through the internet to a processing station;

FIG. 11 shows another preferred embodiment of the invention and shows in block form a combination of the blocks shown in FIGS. 8 and 10 to provide displays simultaneously on a display screen at the travel agency of the indications obtained from the blocks shown in FIGS. 8 and 10 and to provide a printing of a ticket for the trip indicated on the display screen and to provide for an accounting of the purchase of the ticket;

FIG. 12 shows another preferred embodiment of the invention, this combination being formed by the blocks shown in FIG. 8 and by a modification of the blocks shown in FIG. 10;

FIG. 13 is a flow chart showing the operation of the system of FIG. 11 in providing a display simultaneously on the display screen at the travel agency of the flight information provided by the blocks shown in FIG. 11;

FIG. 14 is a flow chart showing the operation of the system of FIG. 11 in providing an accounting, for the flight selected by the client or the travel agency, at the travel agency or at a legacy server also shown in FIGS. 8, 11 and 12.

FIG. 15 is a flow chart showing the operation of the system of FIG. 12 in providing a display simultaneously on the display screen at the travel agency of the flight information provided by the blocks shown in FIG. 12; and

FIG. 16 is a flow chart showing the operation of the system of FIG. 12 in printing at a selected one of a printer at the travel agency or a printer at the travel agency of the fare information for the flight selected by the client of the travel agency.

### DETAILED DESCRIPTION OF A PREFERRED EMBODIMENT OF THE INVENTION

The following is the “Detailed Description” from the parent application:

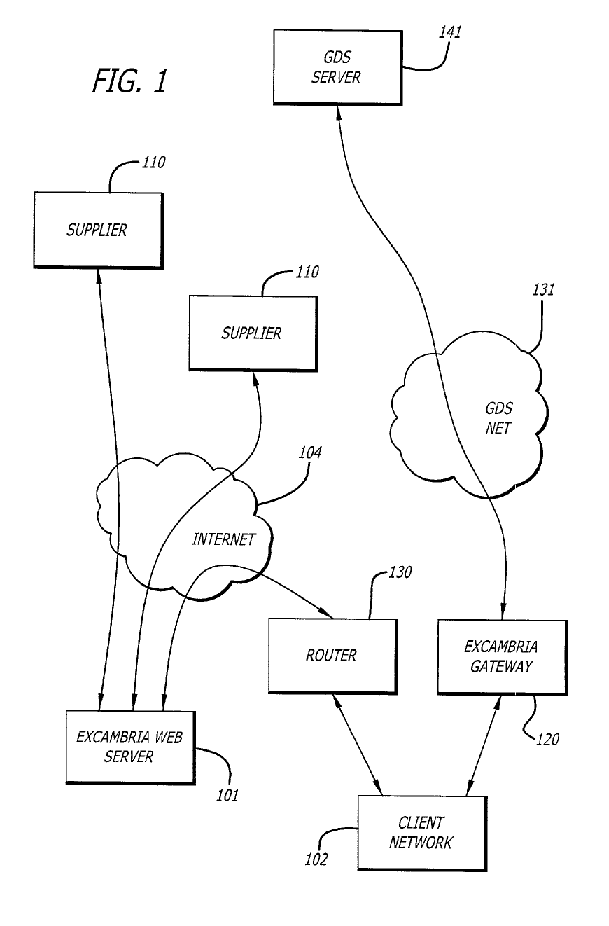

Consumer computer systems and methods are well known in the relevant arts. A high level depiction of one embodiment of this invention is shown in FIG. 1. Box 101 relates to one or more distributed processing servers which are well understood in the art. One particular such server that has been used to embody the invention is the Excambria™ Web Server 101 which is used as an example herein. The Figure depicts a travel agency client computer network 102 which may contain computer workstations (not shown in FIG. 1) that may connect though a router 130 and the Internet 104 to Excambria web server 101. The well known Internet Protocol (IP) is used to communicate over the Internet which is also well known in the art. Excambria™ Web Server 101 in turn connects via Internet 104 to multiple supplier server computers 110 (two shown, but typically many available). Supplier computers may typically operate as e-commerce websites, exchanging requests and responses by means of Internet oriented protocols such as FTP, HTTP, HTML, XML and/or many others. Travel agency client computer network 102 also connects through a Gateway 120 through a proprietary GDS telecommunication networks 131 to one of the several GDS 141 that may be available and which are typically based on mainframe computers. Presently there are four GDS in total and they are well known in the art.

Again referring to FIG. 1, examples of entities that may constitute server machines (box 101) are remote servers, auction servers, transaction servers, inventory systems, supplier managed systems, etc. Parts of the invention may incorporate (have parts that are implemented on) one or more of these example entities. The invention may also incorporate entities that are not listed herein. These entities cooperate with each other in gathering, transmitting, requesting, manipulating, etc . . . travel related service information. The Internet Protocol (IP) is used for communication over the Internet (box 104) as is well understood in the art.

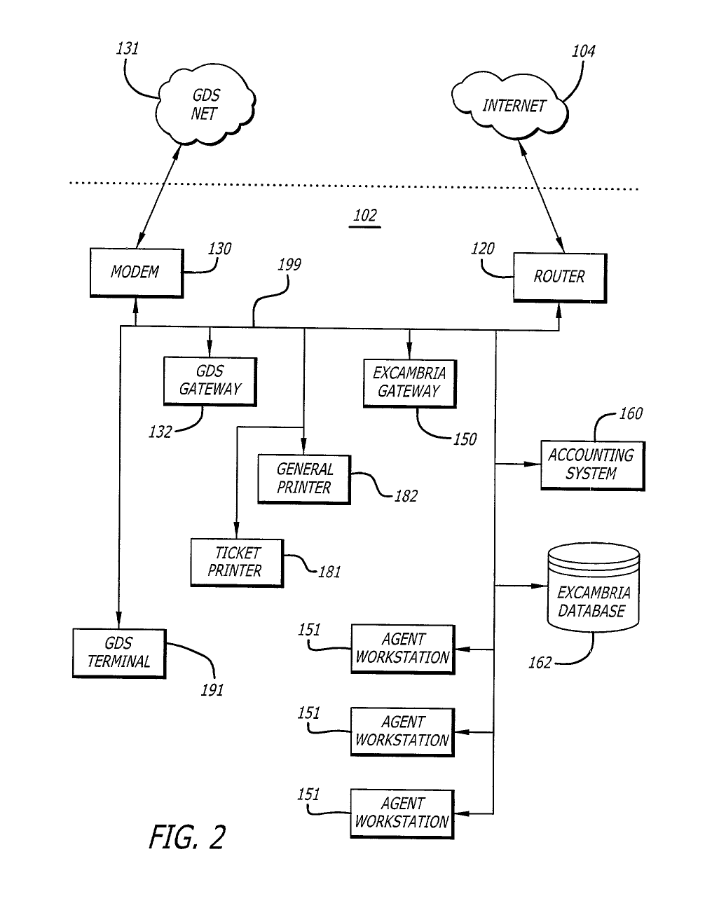

These and other features and advantages may be accomplished by the provision of alternative topologies of computer systems incorporating client computer(s), Internet server computers and GDS. FIG. 2 shows a high level depiction of a travel agency client computer network 102 according to an embodiment of the invention. The exemplary travel agency client computer network 102 may function as depicted in FIG. 1. Still referring to FIG. 2, the travel agency client computer network 102 connects to Internet 104 and GDS proprietary network 131. Gateway 130 connects GDS network 131 and Route 120 connects Internet 104. GDS network 131 provides communication to and from a GDS (not shown in FIG. 2) and Internet 104 provides communication to and from an Excambria server (also not shown in FIG. 2). Various intelligent devices within the travel agency client computer network 102 interconnect, for example, by means of a LAN (local area network) 199 which may be Ethernet, Token Ring or other LAN technology. Optional GDS terminal 191 may be a retained or “legacy” device that may be used by travel agents to access GDS, for example, outside the context of the invention. GDS Gateway 132 operates on behalf of GDS terminal 191 to forward requests and responses to GDS network 131 via modem 130.

One or more agent workstations 151 are provided for individual use by travel agents; typically such workstations may be implemented as software and hardware based upon the ubiquitous PC (Personal Computer). Agent workstations 151 communicate via Excambria gateway 150, LAN 199, Router 120 and Internet 104 with Excambria web server computer (not shown in FIG. 2). Excambria gateway 150 operates on behalf of agent workstations 151 to forward requests and responses to GDS network 131 via modem 130. The accounting system computer 160 may receive messages from many sources and maintains accounting records on an accounting database (not shown). The agent workstations 151 are typically client computers (PC) that implement Excambria client programs. Agent workstations 151 may be referred to, for convenience, as communicating with a GDS, but the Excambria gateway 150 receives requests and responses and forwards them to GDS from agent workstation or vice versa.

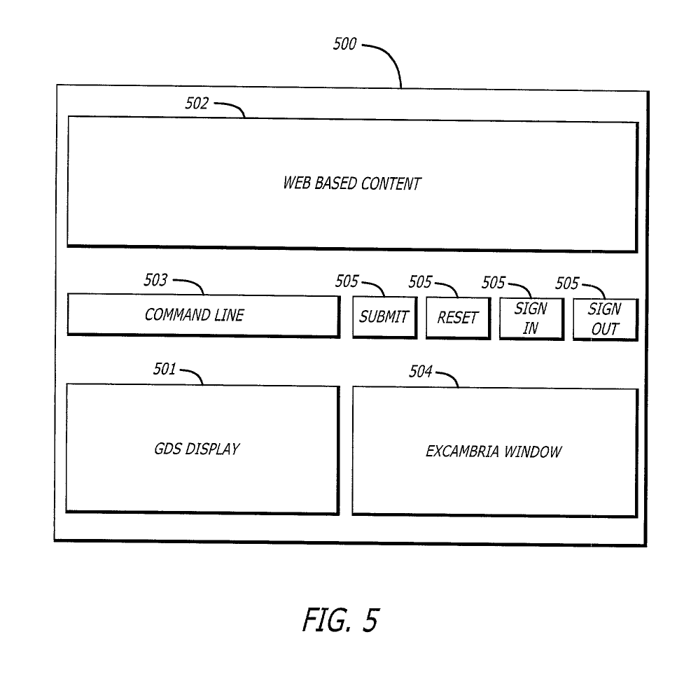

FIG. 5 shows an exemplary client computer display screen 500 layout such as may be used in one embodiment of the invention. The display screen 500 is divided into area or window 501, 502, 503, 504 and perhaps others. In one embodiment, the large area GDS Display window 501 provides a character-oriented scrolling window as may be required by GDS for the traditional human/compute interface thereto. Thus, a terminal emulation of a real GDS terminal optionally including features such as synchronous protocol may be performed using display window 501 and a client computer keyboard. The itinerary may be captured by filtering and interpreting a GDS formatted inquiry using command line 503 in the client computer or in an Excambria gateway or alternatively the itinerary may be entered directly using the human interface (e.g. keyboard) into command line 503. Various command “buttons” 505 for functions may be provided in accordance with the well known computer windows human interface. Window 502 may be used to display information such as inventory and pricing for itineraries located by an Excambria web server (and other web-based content) as is discussed below.

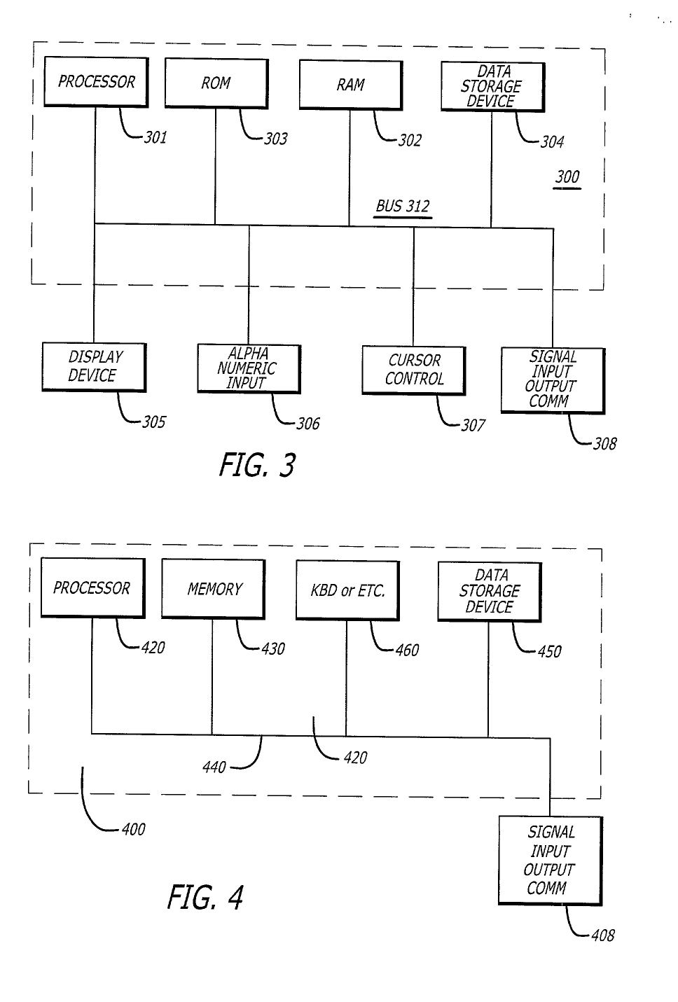

Reference is made to FIG. 3 illustrating a block diagram of a typical client computer system 300 which may be implemented or practiced by using the present invention. Such a client computer system may serve as the client computer system 102 of FIG. 1. Referring again to FIG. 3, client computer system 300 is connected to the Internet (not shown expressly, but typically via data communications port 308, sometimes known as an “I/O interface”). It is to be appreciated that client computer system 300 is exemplary only and that the present invention can operate within a number of different computer systems including general purpose computer systems, embedded computer systems, and others. In the following discussions of the present invention, certain processes and steps are realized as a series of instructs (e.g., software program) that reside within computer readable memory units of system 300 and executed by processors of system 300.

In general, client computer system 300 used by the present invention comprises address/data bus 312 for conveying information and instructions, central processor (CPU) 301 coupled with bus 312 for processing information and instructions, a random access memory (RAM) 302 for storing digital information and instructions, a read only memory (ROM) 303 for storing information and instructions of a more permanent nature. In addition, client computer system 300 may also include a data storage device 304 (e.g., a magnetic, optical, floppy, tape drive, etc.) for storing vast amounts of data, and an I/O interface 308 for interfacing with peripheral devices (e.g. computer network, modem, etc.). More particularly, the memories (e.g., RAM 302, ROM 303, and data storage device 304) of client computer 300 store the instruction codes in accordance with the present invention. A person of ordinary skill in the art will understand that the memories may also contain additional information such as applications programs, network communications programs (e.g., TCP/IP protocol), operating system software, data, etc.

Moreover, client computer system 300 may include a display device 305 for displaying information to a computer user, an alphanumeric input device 306 (e.g., keyboard), and a cursor control device 307 (e.g., mouse, track-ball, light-pen, etc.) for communicating user input information and command selections. This human oriented input and output features may be collectively used as the human interface.

Referring to FIG. 4, server computer 400 comprises central processing CPU 420, memory 430, and communications adapter 408 which are connected together by system bus 440. Such a server computer system may serve as the Excambria server computer system 101 of FIG. 1. Memory 430 stores software. It will be understood by a person of ordinary skill in the art that server computer 400 can also include other elements not shown in FIG. 4 such as disk drives 450, keyboard 460, etc. A person of ordinary skill in the art will understand that memory 430 may also contain additional information such as applications programs, network communication programs (e.g., TCP/IP protocol stack), operating system software, data, etc. Client computer 300 and server computer 400 are linked together by a network, typically the Internet. Furthermore, a person of ordinary skill in the art will understand that the computer systems 300 and 400 may contain more or less than what is shown in FIGS. 3 and 4.

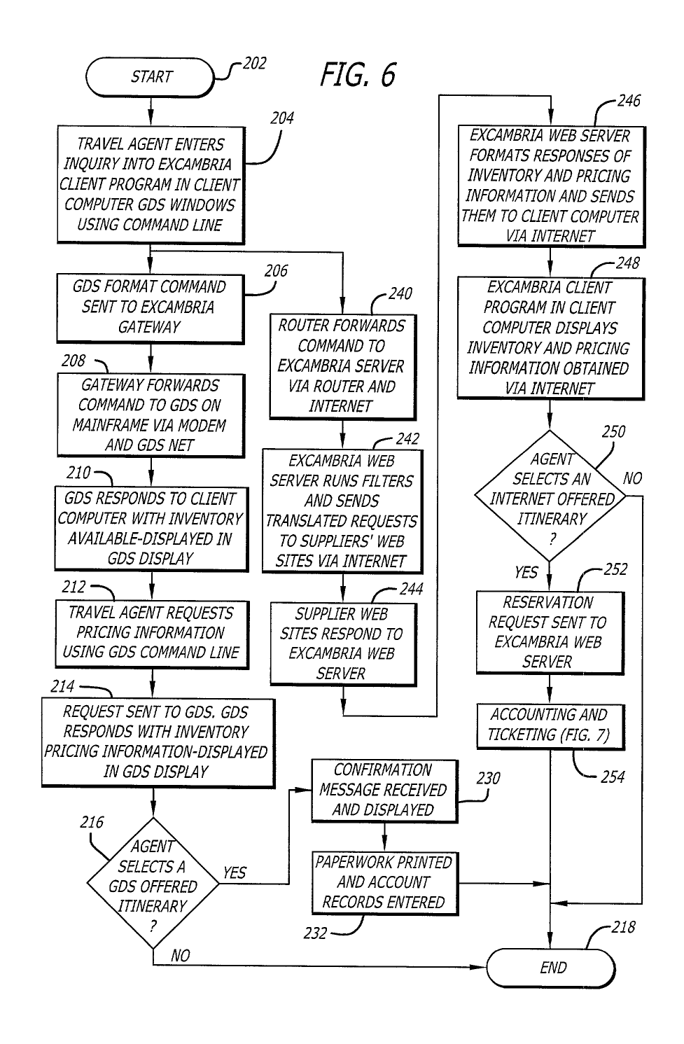

Reference is now made to FIG. 6 illustrating a flow diagram of a reservation method according to an embodiment of the invention. The Figure effectively shows the computer implemented acts to carry out part of the embodiment of the present invention. In general, the acts in FIG. 6 are designed to implement travel agent service mechanisms. The acts in FIG. 6 are carried out when processors 3-1 and 420 (FIGS. 3 and 4) execute the instruction codes stored in the memory of computer systems 300 and 400 (FIGS. 3 and 4). Websites and GDS, as are well known in the art, may also perform some of the necessary functions. It is to be appreciated that the acts described herein are illustrative only and other sequences of steps could be used within the general scope of the invention.

Still referring to FIG. 6, in box 202 the method is stated. In box 204, the travel agent enters an inquiry, such as for flight availability and/or pricing. The travel agent enters the inquiry into Excambria client program in client computer command line window using a command line format. A traditional concise GDS format is used, for example command such as “ALAXSFO22NOV” might be used to inquire as to the availability of airline ticket for travel from Los Angeles to San Francisco on November 22nd next. The client computer software may express the inquiry as a command upon the screen. Then in box 206, the client computer software forwards the GDS format command to Excambria gateway. The gateway may be a separate computer (as shown in FIG. 2) or it could be a physical or logical subsystem of the client computer itself. In box 208 the Gateway forwards command to GDS on mainframe via modem and the GDS Net. In box 210 the GDS responds to client computer (typically via the gateway) with inventory available which is displayed in the GDS display window. In box 212 the travel agent requests pricing information using GDS command line format. In box 214, the request is sent to GDS; GDS responds with inventory pricing information which is displayed in GDS display window of Excambria client program in client computer. In box 216, the travel agent decides whether to select a GDS offered itinerary. If not, the GDS based part of the method ends in box 218. Otherwise, in box 230, the GDS itinerary is selected and a confirmation message received and displayed by old GDS based procedures. In box 232 paperwork is printed and account records entered as for old GDS systems.

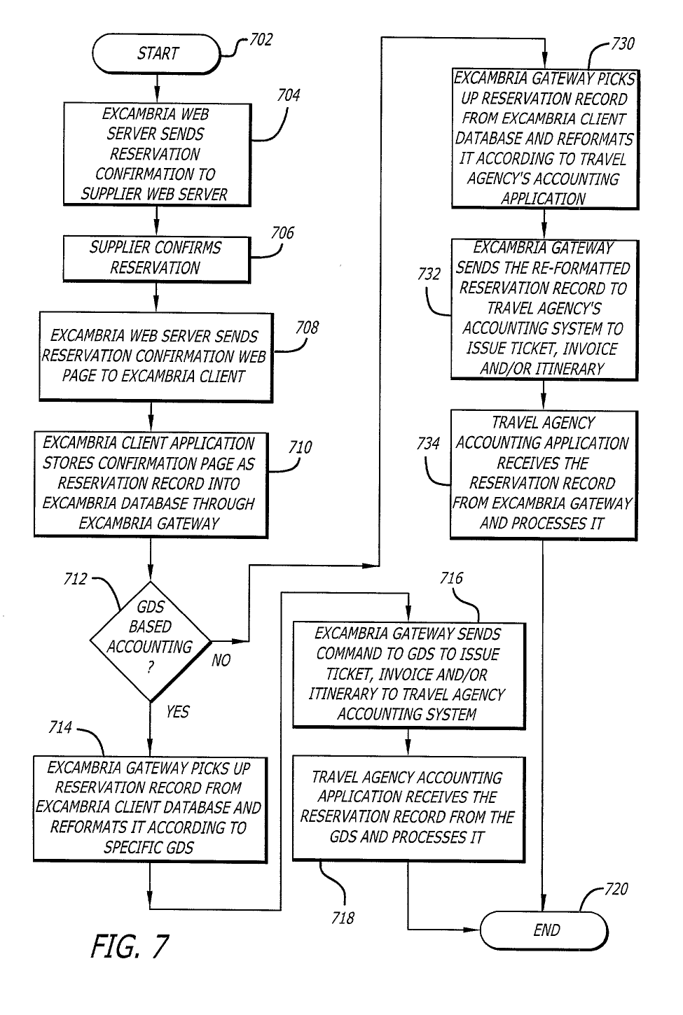

Meanwhile, in box 240, the router forwards a command to Excambria web server via router and Internet. In Box 242, the Excambria Web server runs filters and sends translated requests to suppliers' web sites via the Internet. In box 244, the suppliers' web sites respond to the Excambria Web server. Then, in box 246, the Excambria Web server formats responses of inventory and pricing information and sends them to client computer via the Internet. In box 248, the Excambria client program in the client computer displays inventory and pricing information obtained via the Internet. Then in box 250, the travel agent decides whether to select an Internet offered itinerary. If not, then the web based part of the method ends in box 218. Otherwise, in box 252, a reservation request is sent to Excambria Web server and, in box 254, accounting and ticketing may take place as described below in connection with FIG. 7.

It should be appreciated that, as may be required, the Excambria Web server may translate commands into various forms as may be responded to by the web site of travel service suppliers such as airlines, consolidators, tours operators or the like. Thus, the Excambria server maintains a dialog with various travel sites by sending web formatted commands according to the temporal needs of the many client computers at various locations. In the example given, a request for travel information between Los Angeles and San Francisco would not generate a web site inquiry to the website of British airways since they do not offer US domestic travel. On the other hand, inquiries may be sent to the web sites of the dozen or so airlines that do offer LAX-SFO ticketing. If the agent is dissatisfied with all the itineraries offered or if indeed there are not offers for reason of no availability, the agent may terminate the procedure and start again with, for example, a revised travel date after possible consultation with the prospective traveler. In addition to the functions described in connection with FIG. 6, embodiments of the invention may provide for capturing accounting data for travel services booked via the Excambria Web server. One expanded example of the functions of box 254 according to one embodiment of the invention is shown in FIG. 7. FIG. 7 shows a flow diagram of accounting functions according to an embodiment of the invention. In box 702, the method starts. In box 704, the Excambria Web server sends a reservation confirmation to a supplier web server via the Internet. In box 706, the supplier confirms the reservation. In box 708, the Excambria Web server sends a reservation confirmation web page to the Excambria client program in the client computer. In box 710 the Excambria client application program stores the confirmation page as a reservation record into an Excambria database via the Excambria Gateway. In box 712 a decision is made as to whether GDS based accounting is to be used. If so, in box 714, the Excambria Gateway picks up reservation record from Excambria client database and reformats it according to specific GDS. Then in box 716, the Excambria Gateway sends a command to GDS to issue ticket, invoice and/or itinerary to the travel agency accounting system. In box 718, the travel agency accounting application receives the reservation record from the GDS and processes it and the method ends in box 720.

If GDS based accounting is not to be used, then in box 730 the Excambria Gateway picks up the reservation record from the Excambria client database and reformats it according to the travel agency's accounting application. In box 732, the Excambria Gateway sends the re-formatted reservation record to the travel agency's accounting system to issue ticket, invoice and/or itinerary. In box 734, the travel agency's accounting application receives the reservation record from the Excambria Gateway and processes it and the method ends.

Many other embodiments of accounting functions are feasible within the general scope of the invention. The foregoing embodiments are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those of ordinary skill in the art.

The following is the “Detailed Description of Preferred Embodiment of the Invention” which is being added in this application:

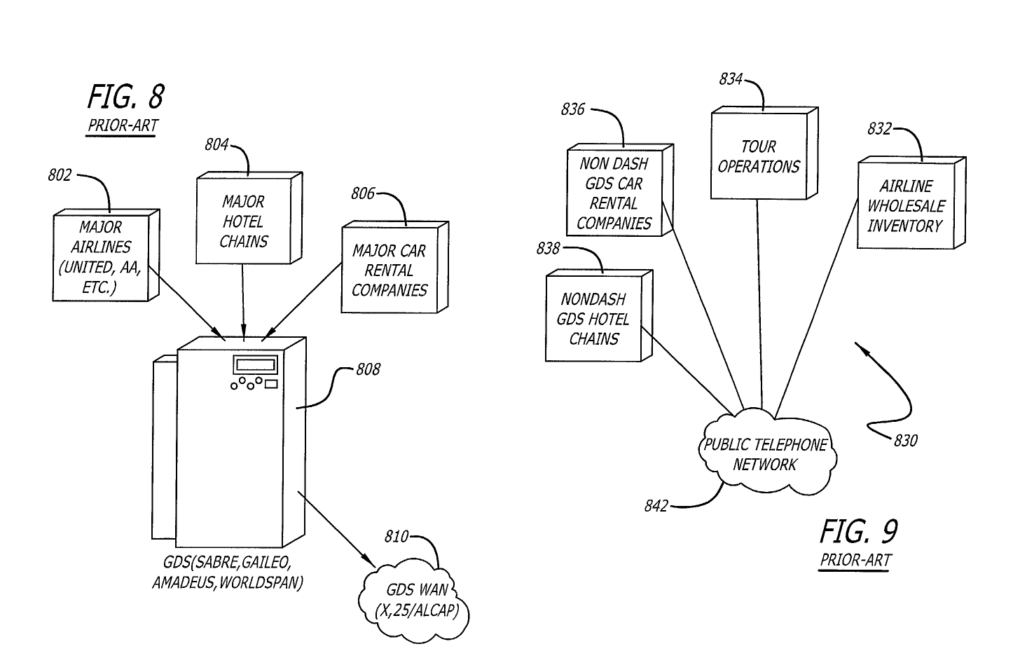

FIG. 8 is a simplified block diagram, generally indicated at 800, of a system of the prior art. The system 800 provides established and published information relating to fares from a number of major airlines 802 (e.g. American, United and Delta) relating to airplane flights and fares. It also includes room availability and room rates from a number of major hotel chains 804 and it further includes information relating to car availability and car rental rates from a number of the major car rental companies 806.

The information from the major airlines 802, the major hotel chains 804 and the major care rental companies 806 are introduced to a global distribution system (GDS) 808 which may be a legacy server. Global distribution systems now in use include Sabre, Galileo, Amadeus and Worldspan. The information from the global distribution system 808 is provided through a wide area network 810 to processing stations such as travel agencies (including a travel agency generally indicated at 812). The travel agency 812 includes a number of substantially identical processing stations, one of which is generally indicated at 814.

The processing station 814 includes a modem 816, a gateway 818, a printer 820, an accounting application 822, a global distribution system display (illustratively Sabre) display terminal 824 and a local area network (LAN) 826. The modem 816 receives information from, and provides information to, the legacy server 808 through the wide area network 810. The modem 816 provides information to, and receives information from, the gateway 818, which may be a server. The gateway 818, the printer 820, the accounting application 822 and the display terminal 824 provide information to, and receive information from, the travel agency local area network 826.

The airlines 802 introduce established and published flight and fare information to the legacy server 808 which stores this information. In like manner, the hotel chains introduce established and published information relating to room availability and room rates to the legacy server 808, and the car rental agencies 806 introduce information relating to car availability and car rates to the legacy server 808. The legacy server 808 stores this information. Whenever requested by the travel agency 812, the legacy server 808 transmits the requested information to the modem 816 in the travel agency processing station 814 through the wide area network 810.

The modem 816 at the processing station 814 introduces the requested information to the gateway 818, which may be a server. The gateway 818 then introduces this information to the local area network 826 which then introduces the information to the appropriate one of the printer 820, the accounting application 822, and the display terminal 824. The printer 820 provides a record of a flight transaction, including the flight number and the flight fare, selected by the agent at the processing station 814. The accounting application 822 provides an accounting at the processing station 814 of the flight transaction selected by the agent. The terminal 824 provides a visual indication on a display screen of information relating to the different flights requested by the agent through the wide area network 810 from the legacy server 808.

It will be appreciated that the discussion above relating to flight information and flight fares applies equally as well to information relating to room availability and room rates when the agent at the processing station 814 requests this information from the legacy server 818 through the wide area network 810. It also applies equally as well to information relating to car availability and car rates when the agent at the processing station 814 requests this information from the legacy server 808 through the wide area network 810.

FIG. 9 shows another embodiment, generally indicated at 830, in the prior art. The embodiment 830 includes airline wholesale inventory 832, tour operators 834, non-GDS car rental companies 836 and non-GDS hotel chains 838. The airline wholesale and retail inventory is that not included in the global distribution system (GDS) 808 shown in FIG. 8. It includes airline fares discounted from the established and published fares. The non-GDS hotel chains 838 are those other than the global distribution system hotel chains included in the server 808. The tour operators 834 sponsor tours to different parts of the world and include such operators as Tauck.

The travel agency 812 obtains information from individual ones of the different inventory sources 832, 834, 836 and 838 by instituting a call from a telephone 840 at the travel station. This call passes through a public telephone network 842 to one of the sources 832, 834, 836 and 838. As will be appreciated, this mode of obtaining information is slow. It is also limited in its capabilities because the lines in the telephone network may be busy. Time is also required to connect the travel agent to the proper provider of information at the telephoned one of the sources 822, 834, 836 and 838. This is particularly true in the telephone systems at the sources where computerized machines, and not humans, answer the phone.

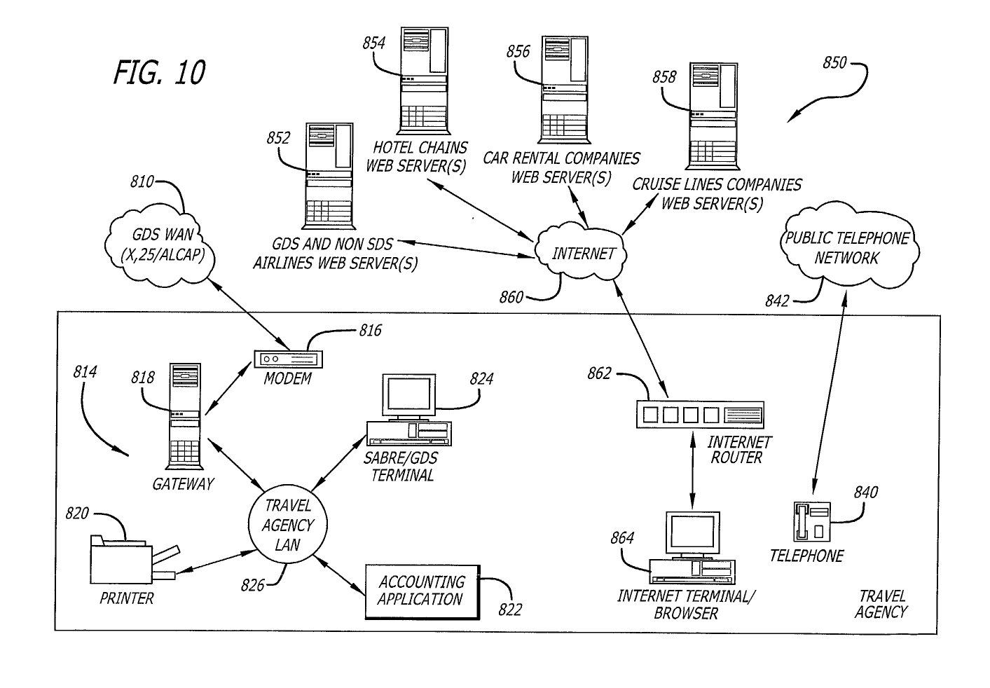

FIG. 10 shows an embodiment, generally indicated at 850, of applicants' invention. Although this embodiment is shown in FIG. 10, it is claimed in a separate application filed by applicants. The embodiment 850 may include web servers 852 of the global distribution system and other airlines not in the global distribution system, web servers 854, web servers 854 of hotel chains, web servers 850 of car rental companies and web servers 858 of cruise line companies. These companies are only illustrative, since web servers from other operational companies may also be included without departing from the scope of the invention. Information from the web servers 852, 854, 856 and 858 is passed through the internet 860 to an internet router 862 in the travel agency 860. The indications from the router 860 pass to an internet display terminal 864 which may include a browser.

As will be seen, requests for information are provided from the travel agency 814 through the internet 860 to the sources 852, 854, 856, and 858. Responses to the requests are made through the internet by the sources 852, 854, 856, and 858. These responses cause information to be displayed on the display terminal 864. Communication between the travel agency 814 and the sources 852, 854, 856, and 858 offer certain advantages. One advantage is that the establishment of the communications between the web servers 852, 854, 856, and 858 and the display terminal 864 is provided in a minimal time. Another advantage is that any possibilities of busy lines as in telephone calls are minimized. A further advantage is that the cost to the operators of the web servers is minimized.

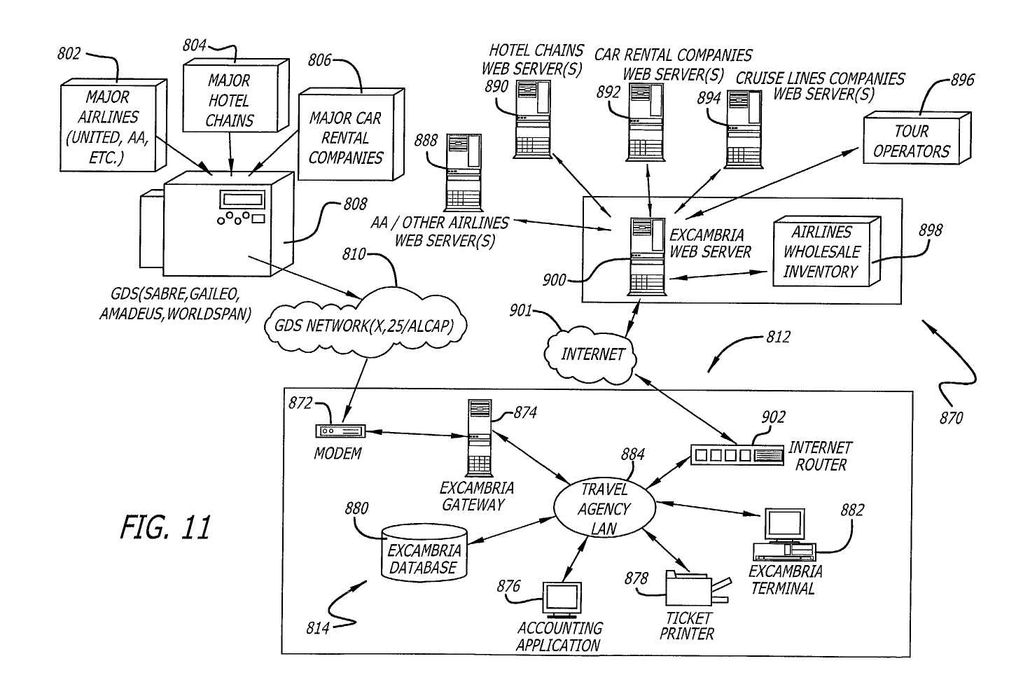

FIG. 11 shows a preferred embodiment of a system, generally indicated at 870, constituting a preferred embodiment of the invention. The system 870 includes the system 800 of the prior art as shown in FIG. 8. Thus, the stages 802, 804, 806, 808, and the wide area network 810 are the same as shown in FIG. 9. However, a modem 872, a gateway 876, an accounting application 876 and a printer 878 are different from corresponding members shown in FIG. 9 even though they have the same designations as the members shown in FIG. 9. The difference in the gateway 874 is indicated in FIG. 11 by the designation of the gateway as an Excambria gateway. An Excambria database 880 and an Excambria display terminal 882 are new in FIG. 11. Although a travel agency local area network 884 in FIG. 11 has the same designation as the network 826 in FIG. 9, it is different from the network 826 in FIG. 9. The differences between correspondingly designated stages in FIGS. 9 and 11 will be explained in detail subsequently. The travel agency local area network 884 is in two (2)-way communication with each of the Excambria gateway 874, the Excambria database 880, the accounting application 876, the ticket printer 878 and the Excambria display terminal 882.

FIG. 11 also includes an arrangement similar to that shown in FIG. 10 and discussed above. FIG. 11 includes a web server 888 for airline flight and fare information. The web server may provide flight and fare information for other airlines (e.g. Southwest Airlines) than those providing information in the legacy server 808. FIG. 11 also shows a web server 890 for other hotel chains than those providing information in the web server 804. In like manner, FIG. 11 includes a web server 892 for other car rental companies than those provided in the web server 806 for the major car rental companies.

FIG. 11 also includes web servers other than those specified in the previous paragraph. For example, a web server 894 provides information relating to cruises (e.g. cities visited, dates and other amenities) and fares offered by major cruise line companies. A web server 896 is also included in FIG. 11 for providing information relating to tour companies (e.g. Tauck Tours). A web server 898 in FIG. 11 also provides airline flight and fare information from the wholesale inventory of thee airlines. It will be appreciated that the web servers capable of being used are not limited to those shown in FIG. 11. It will also be appreciated that other web servers than some of those listed in FIG. 11 can be used.

A two (2)-way communication is provided between each of the server 888, 890, 892, 894, 896 and 898 to an Excambria web server 900. The server 900 is called an Excambria server because it processes information not processed by any other server. For example, a web server corresponding to the Excambria web server 900 is not known to exist in the prior art that processes information from all of the servers 880-898 (even numbers only). The information from the Excambria server 900 is introduced to an internet router 901 in the processing station 814 at the travel agency 812. A two (2)-way communication is provided between the internet router 902 and the travel agency local area network 884.

The operation of the web servers 802-808 (even numbers only) in FIG. 11 in providing information through the wide area network 810 to the processing station 814 in the travel agency 812 and in receiving information through the internet from the web server 808 was discussed previously in connection with FIG. 8. The operation of the web servers 888, 890, 892 and 896 in providing information to the travel agency through public telephone lines 842 has been discussed in detail previously in connection with FIG. 9. However, in FIG. 10, the information from the web servers 888, 890, 892 and 896 is provided to an Excambria web server 900. It is designated as an Excambria web server because it receives information from other sources than is provided to the public telephone lines 842 in FIG. 9 and because there in no web server in FIG. 9.

FIG. 11 shows that information is introduced to the Excambria web server 900 from the web server 888. The web server 888 provides flight and fare information from other airlines than those represented in the legacy web server 808. For example, Southwest Airlines is a good example of this. The Excambria web server 900 also receives information from the web server 894, which provides information from cruise line companies (e.g. Carnival) for various types of cruises such as ocean cruises.

The information from the legacy web server 808 passes through the wide area network 810, the modem 872 and the Excambria gateway 874 to the local area network 884 at the travel agency 814. The information from the Excambria web server 900 passes through the internet router 902 to the local area network 884 at the travel agency 812. The Excambria database 880 receives the information from the travel agency local area network 884.

The information passing to the Excambria database 880 from the legacy server 808 may have a different protocol than the information passing to the database from the Excambria web server 900. The Excambria database 880 converts the non-compatible protocol information from the web servers 808 and 900 into a compatible protocol. This information then passes through the local area network 884 to the Excambria display terminal or display screen 882. The Excambria display terminal 882 is constructed in a manner similar to that shown in FIG. 5 and described above.

The information from the legacy server 808 is displayed in the portion 501 of the display terminal 882 in FIG. 5 and the information from the Excambria web server 900 is displayed in the portion 502 of the display terminal 882 in FIG. 5. A portion 504 of the display terminal 500 in FIG. 5 may indicate the particular flight which the travel agent is investigating at any particular time. For example, the portion 504 of the display terminal 500 in FIG. 5 may indicate that the travel agent is investigating the particulars of a flight 222 on American Airlines from Los Angeles to Boston on Jan. 24, 2002.

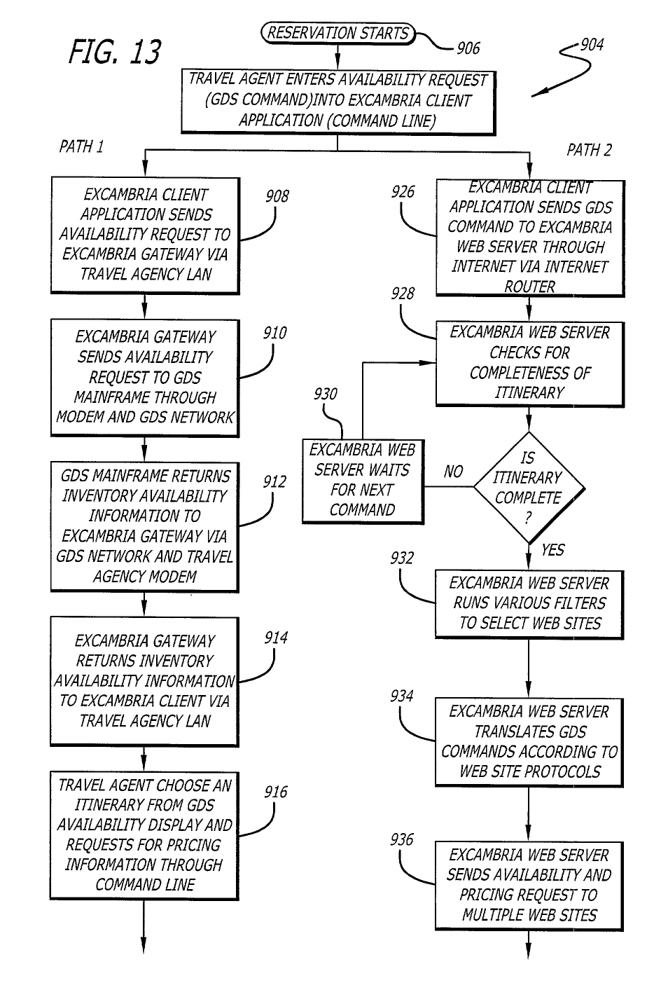

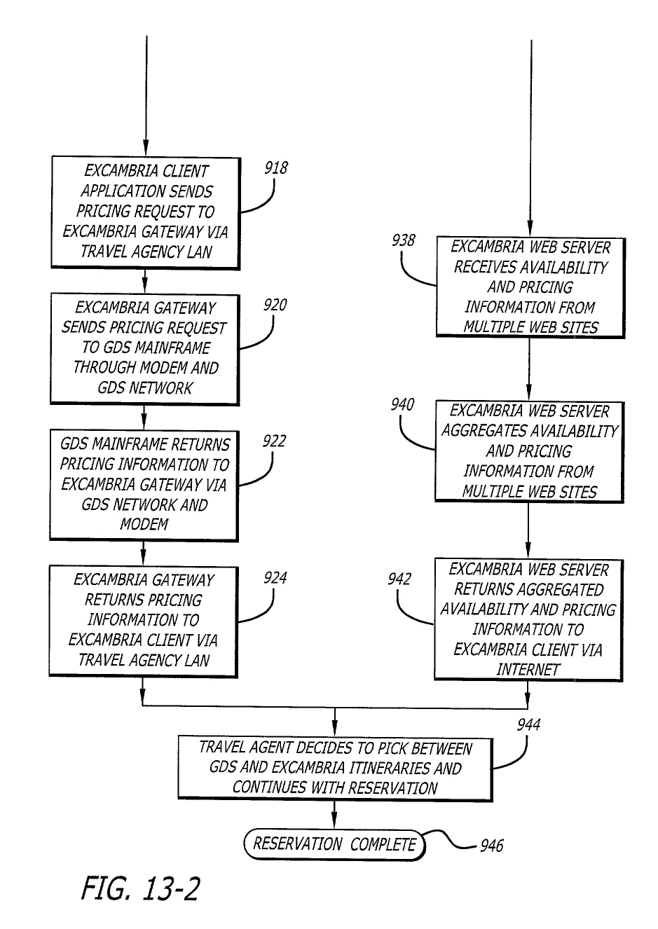

The simultaneous display on the display terminal 882 in FIG. 13 of information from the legacy server 810 and Excambria web server 900 offers certain advantages. It allows the travel agent at the travel agency 812 to see the information from all of the available sources at the same time. For example, it allows the travel agent to view the flight and fare information relating to travel on a particular date between two specified locations from the major airlines at their established and published fares and from the other airlines at their established and published fares and also to see discounted fares from the airlines and wholesale fares from the airlines, all for flights on a specified day between a specified originating location and a specified destination. This allows the travel agent and the client to make a decision based upon all available facts, all of which are made available to the agent at the same time.

When the travel agent and the client select a particular airline flight, the Excambria database 880 provides this information to local area network 884. The local area network 884 then transmits this information to the ticket printer 878 at the travel agency 814 or to the legacy server 808 to have a ticket printed. This choice may be made by the processing station 814 at the travel agency 812. When the ticket is to be printed at the local travel agency 812, the transmission of the request to have the ticket printed at the travel agency is made from the Excambria database 884 through the local area network 884 to the ticket printer 878. When the ticket is to be printed at the legacy server 808, the request to have the ticket printed is made from the Excambria database 880 through the local area network 884, the Excambria gateway 874 and the modem 872 to the legacy server 808.

In addition to the advantages discussed above, the system in FIG. 11 provides other advantages, particularly to the travel agent at the travel agency 812. As previously indicated, the airlines, particularly the major airlines listed in the legacy server 808, have been reducing the commissions paid to travel agents for generating tickets for flights on these airlines. The system in FIG. 11 provides the travel agents an opportunity to obtain discounted fares from the airlines and to charge a commission on these discounted fares when the travel agent quotes the discounted fares to the client. The travel agent can do this by quoting to the client a single price which includes the discounted fare and the commission. The client profits from this discounted fare (even with the commission added) because the client does not have to pay the established and published fare of the airlines. There is another advantage in the system of FIG. 11 to the travel agent. This results from the fact that the travel agent can obtain information from all of the available sources in a minimal amount of time and can have all of this information posted on the display terminal 882 at the same time. This facilitates the selection by the agent of the best flight arrangement for the client in a minimal period of time, this decision being based upon all of the available facts. The system is also advantageous to the airlines because it allows the airlines to the significantly reduce their cost, particularly their selling and marketing expenses. The system is further advantageous to the efficient airlines because their fares will be below those of the inefficient airlines and this will be readily apparent on the split screen 500 in FIG. 5.

FIG. 13 is a flow chart, generally indicated at 904, showing the successive steps involved in operating the system shown in FIG. 11 and described above. As a first step (906), the system is activated. The travel agent at the travel agency 812 then sends (908) an availability request through the local area network 884 and the Excambria gateway 874 to the legacy web server 808 (910). The global distribution system then returns (912) the inventory availability information to the Excambria gateway 874 through the wide area network 810 and the modem 872. In other words, the Excambria web server 808 indicates to the Excambria gateway 874 whether seats are available on a specified flight and, if so, what the prices of the seats are. The Excambria gateway 874 indicates this seat availability, and the prices of the available seats, through the local area network 884 to the Excambria terminal 882. This is indicated at 914 in FIG. 13.

At 916, the travel agent selects an itinerary from the global distribution system available in the legacy server 808 and requests pricing information relating to the itinerary. The travel agency 812 sends, as indicated at 918 and 920, a pricing request for the selected flight to the legacy server 808 through the travel agency local area network 884, the Excambria gateway 874, the modem 872 and the wide area network 810. The legacy server 808 then sends the requested information to the display terminal 882 at the processing station 814 in the travel agency 812 through the wide area network 810, the modem 872 and the local area network 884, as indicated at 922 and 924 in FIG. 13.

The travel agent at the travel agency 812 may also send requests for information through the local area network 884, the router 902 and the internet 901 to the Excambria web server 900. This is indicated at 926 in FIG. 13. The Excambria web server 900 checks (928) for the completeness of the itinerary transmitted to it from the local area network 884. If the itinerary is not complete, the Excambria web server 900 waits for the next command from the local area network 926. See 930 in FIG. 13. If the itinerary is complete, the Excambria web server 900 activates (932) various filters to select web sites in the Excambria server. This is indicated at 932 in FIG. 13. The Excambria web server 900 then translates (934) the global distribution system commands from the web server 908 according to the protocols in the selected web sites.

The Excambria web server 900 then sends (936) the flight availability and pricing requests to multiple websites in the Excambria server and receives (938) the flight availability and pricing information from the multiple web sites. The Excambria web server 900 aggregates (940) the flight availability and pricing information from the multiple web sites. As indicated at 942, the Excambria web server 900 thereafter submits the flight availability and pricing information to the Excambria database 880 at the processing station 814 in the travel agency 812. The travel agent then selects a flight itinerary, and a pricing information for that itinerary, from the global distribution system information in the legacy server 808 and the individual flight in the Excambria web server 900. The reservation of the selected flight itinerary and fare is now complete. See 946 in FIG. 13.

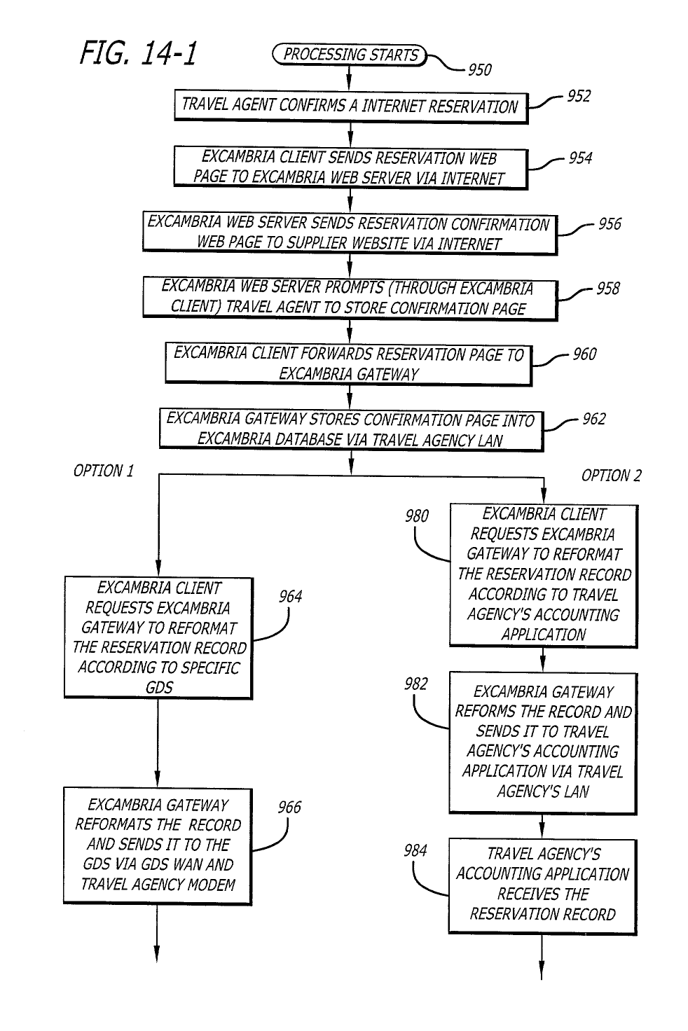

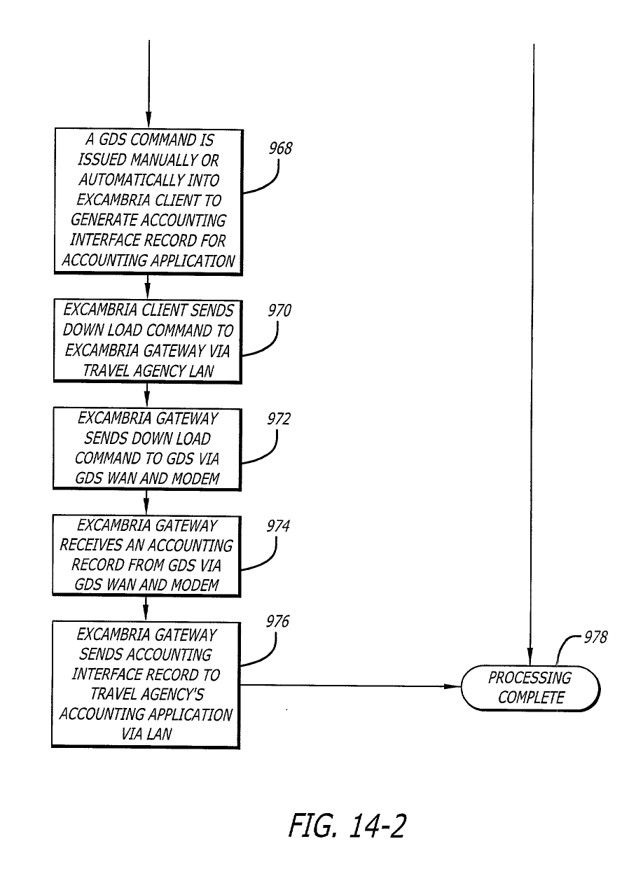

FIG. 14 is a flow chart indicating the steps in providing an accounting after the flight itinerary and price have been selected on the basis of the information in the Excambria database 880 in FIG. 11. The processing of the accounting commences at 950 in FIG. 14. The travel agent confirms a ticket reservation, as at 952, on the internet 901 or in the global distribution system network 810. See 954 in FIG. 14. The travel agency 812 then sends (954) the reservation web page to the Excambria web server 900 via the internet 901. The Excambria web server 900 thereafter sends (956) the reservation confirmation web page to the web site at the travel agency 812 through the internet 901 and prompts (958) the travel agency to store the confirmation page. The travel agency 812 subsequently forwards the reservation page to the Excambria gateway 874 at the travel agency 814. See 960 in FIG. 14. The Excambria gateway 874 thereafter stores the flight confirmation page in the Excambria database 880 at the travel agency 812 in FIG. 11 as indicated at 962 in FIG. 14.

Thee are then two (2) options. One option is indicated in the sequence of blocks at the left end below the block 962. The other option is indicated in the sequence of blocks at the right and below the block 962. In option one (1) at the left end below the block 962, the travel agent requests through the Excambria database 880 the legacy server 808 in FIG. 11 to reformat the reservation on record in accordance with the global reservation system protocol. This is indicated at 964 in FIG. 14. The Excambria gateway 874 reformats the reservation record and sends it to the legacy server 808 via the modem 872 and the wide area network 810. See 966 in FIG. 14. A global distribution system command is then issued (968) manually or automatically at the travel agency 812 to generate an accounting interface record for the accounting 876 in FIG. 11.

The processing station at the travel agency 812 thereafter sends a load command to the legacy server 808 through the modem 872 and the wide area network. This is indicated at 972. After that, the Excambria gateway 874 receives an accounting record from the legacy server 804 through the wide area network 810 and the modem 872. See 974 in FIG. 14. The Excambria gateway then sends the accounting interface record to the accounting application 876 through the local area network 884 in FIG. 11. The accounting application makes a recording of such information as the client, the ticket sold to the client, and the price of the ticket. The process is now complete. See 978 in FIG. 14.

In option two (2), after the storage of the confirmation page in the Excambria database 880 (see 962), the travel agency 814 requests (980) the Excambria gateway 874 to reformat the reservation record according to the accounting application 876. (See 982 in FIG. 14.) The Excambria gateway 874 then provides this reformatting and sends it to the accounting application 876 through the local area network 884. See 982 in FIG. 14. The accounting application 876 receives and records the reservation information as at 984. The processing of the accounting record in now complete (978).

The ticketing of the selected flight by the travel agent for the client may have a flow chart substantially identical to the flow chart shown in FIG. 14. However, instead of specifying the accounting application as in FIG. 14, the flow for the ticket printer would substitute the word “printer” for the words “accounting applications”. In this way, the ticket can be printed either at the legacy server 808 (option 1) or the ticket can be printed at the ticker printer 878 (option 2).

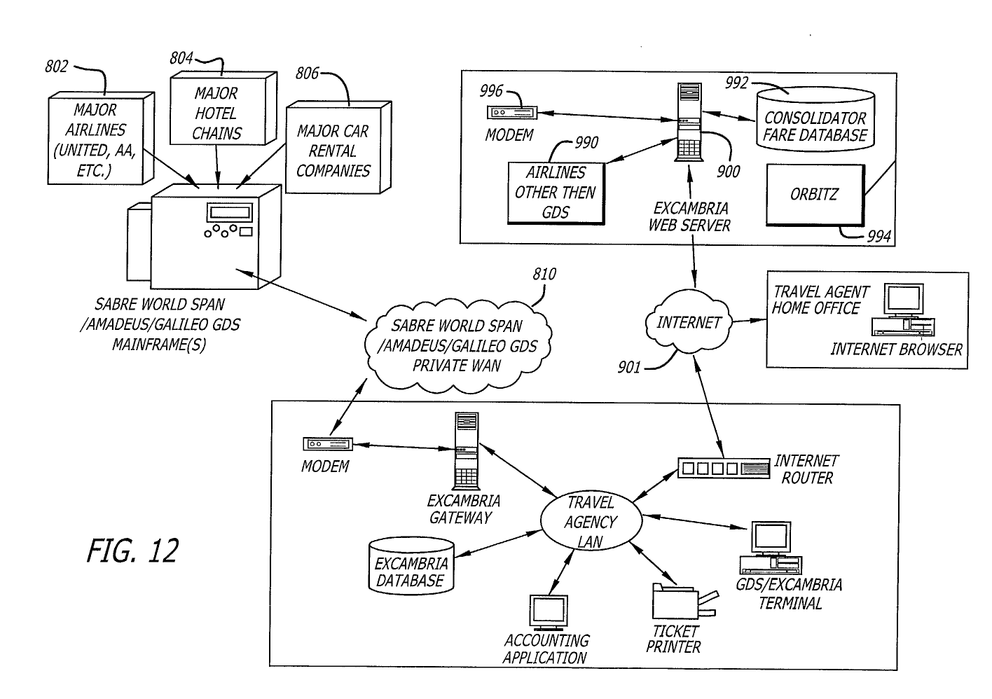

FIG. 12 is similar to FIG. 11. However, in place of the six (6) web servers feeding information into the Excambria web server 900 as shown in FIG. 11, three (3) other web servers feed information into, and receive information from, the Excambria web server 900. These are (a) a web server 990 providing information relating to airlines (e.g. Southwest Airlines) other than the primary airlines (e.g. American, United and Delta) in the legacy web server 808, (b) a web server 992 providing a database for consolidators (companies which purchase blocks of tickets from the airlines at discounted prices and offer these tickets to the public at prices above the discounted prices but below the established and published prices and (c) a web server 994 for Orbitz. Information in the Orbitz web servers 994 relates to last minute reductions in price by the airlines for flights which will be somewhat empty if the prices of the flights are not steeply discounted. The information from the web servers 990, 992 and 994 are introduced through the internet 901 to the travel agency 812 and information from the travel agency is introduced through the internet to the web servers 990, 992 and 994.

It will be appreciated that the web servers 990, 992 and 994 are shown in FIG. 12 separately from the web servers 888-898 (even members only) in FIG. 11 only for purposes of convenience. The web servers associated with the Excambria web server 900 in FIGS. 11 and 13 may constitute any one of any combination of the web servers shown in FIGS. 11 and 13. Furthermore, the use of the system shown in FIGS. 11 and 12 is not limited to the web servers shown in FIGS. 11 and 13. This will be obvious to a person of ordinary skill in the art.

A modem 996 is shown in FIG. 12 for providing a two (2)-way communication between the Excambria web server 900 and the legacy server 808. This two (2)-way communication is provided through the wide area network 810 between the modem 996 and the legacy server 808.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the claims.

What is claimed is:

1. A method of presenting offers of travel services comprising:
a. providing a client computer having a human interface;
b. inputting via the human interface, a request for details of travel services, the request being in a format intelligible to a GDS;
c. sending a first copy of the request to the GDS;
d. sending, through the Internet, a second copy of the request to a server computer;
e. receiving, from the GDS, a first details of travel services;
f. receiving, via the Internet, from the server computer a second details of travel services, the second details of travel services having been received by the server computer in response to a supplier request, from the server computer to a supplier, wherein the supplier request is composed responsive to a data content of the request for services; and
g. outputting, via the human interface, a representation of the first and the second details of travel services.

2. The method of claim 1 wherein
the supplier response is a web response received from a supplier web site and the supplier request is a web request sent via the Internet.

3. The method of claim 1 further comprising
the act of emulating a GDS terminal.

4. A method of generating an accounting record comprising the acts of:
receiving in a client application program a reservation confirmation from Internet;
reformatting the reservation confirmation according to a GDS (global distribution system) to create a reformatted reservation record;
sending the reformatted reservation record to the GDS; and
receiving by an accounting application program, an accounting record sent by the GDS in response to receiving the reformatted reservation record.

5. A method of generating an accounting record comprising the acts of:
receiving in a client workstation application program a reservation confirmation from Internet;
reformatting, in a gateway, the reservation confirmation according to an accounting application program to create a reformatted reservation record;
sending the reformatted reservation record to an accounting in an application system computer; and
receiving by the accounting application program the reformatted reservation record sent by the gateway.

6. A method of providing at a processing station an indication of a transaction defined by a plurality of specified parameters, including the steps of:
providing legacy transactions, and the costs of performing the legacy transactions, meeting the plurality of specified parameters,
providing individual transactions, and the costs of performing the individual transactions, constituting other than the legacy transactions and meeting the plurality of specified parameters,
providing for a display, on a first portion of the display screen, of the legacy transactions and the cost of performing each of the legacy transactions, and
providing for a display, on a second portion of the display screen different from the first portion of the display screen, of the individual transactions and the cost of performing each of the individual transactions.

7. A method as set forth in claim 6 wherein
the legacy transactions are airline flights from an originating position to a destination on a particular date and the costs of the legacy transactions are provided through a wide area network to the first portion of the display screen and wherein
the individual transactions are airline flights from the originating position to the destination on the particular date and wherein
each of the individual transactions, and the cost of each of the individual transactions are provided through the internet to the second portion of the display screen.

8. A method as set forth in claim 7 wherein
the costs of the legacy flights are established and published prices normally charged for the legacy flights and wherein the costs of the individual flights are prices discounted from the normally charged prices.

9. A method as set forth in claim 7 wherein
the legacy flights are the flights provided by a first group of airlines and the costs of the legacy flights are established and published prices normally charged by these airlines for these flights and wherein
the individual flights are flights by airlines other than the first group of airlines and the costs of these individual flights are the prices charged by the other airlines for these flights.

10. A method as set forth in claim 6 wherein
the legacy transactions are cruises from an originating position to a destination on a particular date and wherein the legacy transactions and the costs of the legacy transactions are provided through a wide area network to the first portion of the display screen and wherein
the individual transactions are cruises from the originating positions to the destinations on the particular date and wherein each of the individual transactions and the cost of each of the individual transactions are provided through the internet to the second portion of the display screen and wherein
the costs of the legacy cruises are the prices normally charged for the flights and wherein the costs of the individual cruises are the prices discounted from the normally charged prices for the cruises.

11. A method as set forth in claim 6 wherein
the legacy transactions are car rentals from a first group of car rental agencies and the costs of the car rentals from the first group of rental agencies and wherein the legacy transactions and the costs of the legacy transactions are indicated in the first portion of the display screen and wherein
the individual transactions are car rentals from car rental agencies other than the first group of car rental agencies and wherein the individual transactions and the costs of the individual transactions are indicated in the second portion of the display screen.

12. A method as set forth in claim 6 wherein
the legacy transactions are hotel reservations from a first group of hotels and the costs of the hotel reservations from the first group of hotels and wherein the legacy transactions and the costs of the legacy transactions are indicated in the first portion of the display screen and wherein
the individual transactions are from hotel reservations other than the first group of hotels and wherein the individual transactions and the costs of the individual transactions are indicated in the second portion of the display screen.

13. A method of providing at a processing station an indication of a minimal price for an event, including the steps of:
providing prices for the event at the processing station from a plurality of first sources offering established and published prices for the event,
providing prices for the event at the processing stations from a plurality of second sources offering special prices for the event,
providing a display screen having first and second display portions,
displaying in the first portion of the display screen the established and published prices provided in the processing station of the event from the first sources, and
displaying in the second portion of the display screen the special prices provided by the processing station of the event from the second sources.

14. A method as set forth in claim 13 wherein
the special prices are provided through the internet to the second portion of the display screen and wherein
the established and published prices are provided to the first portion of the display screen through a medium other than the internet.

15. A method as set forth in claim 13 wherein
the special prices on the second portion of the display screen are displaced simultaneously with the established and published prices on the first portion of the display screen.

16. A method as set forth in claim 13 wherein
the prices from the first sources are provided in a first protocol and wherein
the prices from the second sources are provided in a second protocol different from the first protocol and wherein
the first and second protocols are made compatible in the processing system to provide for the selection of one of the events, and price for that event, from the first and second sources.

17. A method as set forth in claim 13 wherein
the special prices on the second portion of the display screen are displaced simultaneously with the established and published prices on the first portion of the display screen and wherein
the prices from the first sources are provided in a first protocol and wherein
the prices from the second sources are provided in a second protocol different from the first protocol and wherein
the first and second protocols are made compatible in the processing system to provide for the selection of one of the events, and price for that event, from the first and second sources.

18. A method as set forth in claim 14 wherein
the special prices on the second portion of the display screen are displayed simultaneously with the published prices on the first portion of the display screen and wherein
the prices from the first sources are provided in a first protocol and wherein
the prices from the second sources are provided in a second protocol different from the first protocol and wherein
the first and second protocols are made compatible in the processing system to provide for the selection of one of the events, and the price for that event, from the first and second sources.

19. A method of providing at a processing station an indication of a minimal price for an event, including the steps of:
providing retail prices for the event from legacy sources,
providing discounted prices for the event from sources other than the legacy sources,
providing a display screen having first and second display portions,
displaying in the first portion of the display screen the retail uses of the event, and
displaying in the second portion of the display screen the discounted prices for the event.

20. A method as set forth in claim 19, including the step of:
displaying in one of the portions of the display screen the selection of one of the prices from the retail prices shown in the first portion of the display screen and the discounted prices shown in the second portion of the display screen.

21. A method as shown in claim 19 wherein
the legacy prices are provided through a wide area network and wherein
the discounted prices are provided through the internet.

22. A method as set forth in claim 19 wherein
the event is an airline flight on a specified day from a first specified locality to a second specified locality and wherein
the legacy system is selected from a group of main frames including Sabre, Galileo, Amadeus and Worldspan and wherein
the other sources provide air fares selected from individual airlines not within any of the mainframe groups, Orbitz and an inventory of consolidated air fares.

23. A method as set forth in claim 20 wherein
the legacy prices are provided through a wide area network and wherein
the discounted prices are provided through the internet and wherein
the event is an airline flight on a specified day from a first specified locality to a second specified locality and wherein
the legacy system is a selected from a group of main frames including Sabre, Galileo, Amadeus and Worldspan and wherein
the other sources include air fares selected from individual airlines not within any of the mainframe groups, Orbitz and an inventory of consolidated air fares.

24. A method of providing at a processing station an indication of a transaction defined by a plurality of specified parameters, including the steps of:
providing, in a first protocol, a plurality of legacy transactions including the cost of performing each of the transactions,
providing, in a second protocol different from the first protocol, a plurality of individual transactions including the cost of performing each of the transactions,
providing a protocol compatible with the first and second protocols to obtain in the compatible protocol the indications of the legacy transactions and the individual transactions,
providing a display in a first portion of the display screen, using the compatible protocol, of the legacy transactions,
providing a display in a second portion of the display screen, using the compatible protocol, of the individual transactions.

25. A method as set forth in claim 24 wherein
the legacy transactions are flights between originating positions and destinations of scheduled flights on particular days at prices established and published by specific airlines and offered to the public and wherein
the individual flights are the specific legacy flights at prices discounted from the established and published prices.

26. A method of providing at a processing station an indication or a minimal price for a transaction, including the steps of:
providing prices for the transaction at the processing station from a plurality of first sources offering established and published prices for the transaction,
providing for the transmission of the published prices from the first sources to the processing station through a wide area network,
providing for the transmission of the published prices from the first sources to the processing station through a wide area network,
providing from the first sources prices discounted for the transactions from the published prices form the first sources,
providing for the transmission of the published prices from the first sources to the processing station through the network, and
displaying the published prices from the first source and the discounted prices from the first source simultaneously on a display screen at the processing station.

27. A method as set forth in claim 28 wherein
the published prices for the transactions are provided with a first protocol and wherein
the discounted prices for the transactions are provided with a second protocol different from the first protocol and wherein
the first and second protocols are made compatible and wherein
the published prices and the discounted prices in the compatible format are displayed simultaneously on the display screen.

28. A method as set forth in claim 28, including the steps of:
providing prices for the transaction at the processing station from at least one second source offering published prices for the second source, the second source being different from the first source,
providing for the transmission of the published prices from the at least one second source to the processing station through the internet, and
displaying the published prices from the at least one second source on the display screen simultaneously with the display of the published prices and the discounted prices from the first sources.

29. A method as set forth in claim 28 wherein
the published prices from the at least one second source is provided with a protocol different from one of the first and second protocols and wherein
the protocol from the at least one second sources is made compatible with the compatible first and second protocols and wherein
the published prices and discount prices from the first sources and the published price from the at least one second source, in the compatible format, are displayed simultaneously on the display screen.

30. A method as set forth in claim 31 wherein
the published prices from the first sources in the compatible format are displayed on a first portion of the display screen and wherein
the discounted prices from the first sources, and the published prices from the at least one second source, are displayed in the compatible format on a second portion of the display screen.

31. A method of providing for billing a particular transaction, including the steps of:
providing in a legacy server legacy transactions, and the prices of performing the legacy transactions, relating to the particular transaction,
providing in at least a second server individual transactions, and the prices of performing the individual transactions, relating to the particular transaction,
providing, at a processing station displaced from the legacy server, a database having a volatile memory for storing indications of the legacy transactions relating to the particular transaction, and the prices of performing the legacy transactions and indications of the individual transactions and the prices of performing the individual transactions,
indicating in the database a selected one of the legacy transactions and the individual transactions as the particular transaction and indicating the price for performing the selected one of the legacy and individual transactions, and
communicating to the legacy server the indications of the selected one of the legacy and individual transactions and the price for performing the selected one of the legacy and individual transactions.

32. A method as set forth in claim 33, including the steps of:
providing a printer at the legacy server, and
printing a ticket in the printer at the legacy server a ticket providing for the performance of the selected one of the legacy and individual transactions as the particular transaction.

33. A method as set forth in claim 33 wherein
the legacy transactions have a first protocol and wherein
the individual transactions have at least a second protocol different from the first protocol and wherein
the database at the processing station provides a protocol compatible with the first protocol and the at least second protocol and processes the legacy transactions and the individual transactions in the compatible protocol.

34. A method as set forth in claim 36 wherein
the indications of the legacy transactions are provided to the database at the processing station through the a wide area network and wherein
the indications of the individual transactions are provided through the internet to the database at the processing station.

35. A method as set forth in claim 33 wherein
the transactions are airline flights on a particular date between a particular originating location and a particular destination and wherein
the legacy transactions are airline flights serviced by a global distribution system including Sabre, Galileo, Amadeus and Worldspan and provided by a number of the major airlines and wherein
the individual transactions are airline flights provided by a number of airlines other than those serviced by the global distribution system.

36. A method as set forth in claim 37 wherein
the legacy transactions have a first protocol and wherein
the individual transactions have at least a second protocol different from the first protocol and wherein
the database at the processing station provides a protocol compatible with the first protocol and the at least second protocol and processes the legacy transactions and the individual transactions in the compatible protocol and wherein
the indications of the legacy transactions are provided to the database at the processing station through a wide area network and wherein
the indications of the individual transactions are provided through the internet to the database at the processing station and wherein
the transactions are airline flights on a particular date between a particular originating location and a particular destination and wherein
the legacy transactions are airline flights serviced by a global distribution system, including Sabre, Galileo, Amadeus and Worldspan and provided by a number of the major airlines and wherein
the individual transactions are airline flights provided by a number of airlines other than those serviced by the global distribution system.

37. A method as set forth in claim 33, including the steps of:
providing an accounting application at the legacy server, and
operating the accounting application at the legacy server to provide an accounting record of the selected one of the legacy and individual transactions as the particular transaction and to provide an accounting record of the price of the selected one of the transactions.

38. A method of providing at a processing station for a billing of a particular transaction, including the steps of:
providing legacy transactions and the price of performing the legacy transactions,
providing individual transactions and the price of performing the individual transactions,
providing a local area network and a printer at the processing station,
providing at the processing station a database for storing volatile information including a selected one of the legacy transactions and the individual transactions and the price of performing the selected one of the legacy transactions and the individual transactions as the particular transaction,
providing for the passage through the internet to the printer of the selected one of the legacy transactions and the individual transactions as the particular transaction and of the price for performing the selected one of the legacy transactions and the individual transactions, and
printing at the printer the selected one of the legacy transactions and the individual transactions and the cost of performing the selected one of the legacy transactions and the individual transactions.

39. A method as set forth in claim 40 wherein
the legacy transactions and the price of performing the legacy transactions are transmitted to the processing station through a wide area network and wherein
the individual transactions and the price of performing the individual transactions are transmitted to the processing station through the internet.

40. A method as set forth in claim 40 wherein
the legacy transactions are provided in a first protocol and wherein
the individual transactions are provided in a second protocol and wherein
the first and second protocols are made compatible at the processing station.

41. A method as set forth in claim 40 wherein
the legacy transactions and the price for performing the legacy transactions are displayed in a first portion of a display screen at the processing station and wherein
the individual transactions and the prices for performing the individual transactions are displayed in a second portion of the display screen at the processing station.

42. A method as set forth in claim 41 wherein
the legacy transactions are provided in a first protocol and wherein
the individual transactions are provided in a second protocol and wherein
the first and second protocols are made compatible at the processing station and wherein
the legacy transactions and the price for performing the legacy transactions are displayed in a first portion of a display screen at the processing station and wherein
the individual transactions and the prices for performing the individual transactions are displayed in a second portion of the display screen at the processing station.

43. In a method of billing a particular transaction, the steps at a processing station of:
receiving, at a database at the processing station from a global distribution system, indications of legacy transactions fulfilling the particular transaction,
receiving, at a database from sources other than the global distribution system, individual transactions fulfilling the particular transaction,
selecting, at the database for the particular transaction, one of the legacy transactions and the individual transactions, and
providing for the printing of a ticket for the particular transaction at one of the processing stations and the global distribution system.

44. In a method as set forth in claim 45 wherein
the indications of the legacy transactions are in a first protocol and the indications of the individual transactions are in a second protocol,
the steps of:
making the first and second protocols compatible with each other, and
selecting in the compatible protocol one of the legacy transactions and the individual transactions as the particular transaction.

45. In a method as set forth in claim 45, the steps of:
receiving the indications of the legacy transactions through a wide area network at the database of the processing station, and
receiving the indications of the individual transactions through the internet at the database of the processing station.

46. In a method as set forth in claim 45 wherein
the legacy indications and the individual indications are for an airplane flight on a particular date between a particular originating location and a particular destination and wherein
the legacy indications are provided by a global distribution system representing several of the primary airlines and wherein
the individual indications are provided by other airlines than the primary airlines.

47. In a method as set forth in claim 45 wherein
the legacy indications and the individual indications are for an airplane flight on a particular date between a particular originating location and a particular destination and wherein
the indications of the legacy flights are provided by a global distribution system representing several of the primary airlines and the legacy indications are provided for airline flights at established and published prices and wherein
the individual indications are provided by the airlines in the global distribution system for the airline flights at prices discounted from the established and published prices.

48. In a method as set forth in claim 45 wherein
the legacy indications and the individual indications are for an airplane flight on a particular date between a particular originating location and a particular destination and wherein
the indications of the legacy flights are provided by a global distribution system representing several of the primary airlines and the legacy indications are provided for airline flights at established and published prices and wherein
the individual indications are provided by consolidators who purchase blocks of airline tickets at prices discounted from the established and published prices and offer these tickets to the public at prices which are between the established and published prices and the discounted prices.

49. In a method as set forth in claim 46, including the steps of:
receiving the indications of the legacy transactions through a wide area network at the database of the processing station,
receiving the indications of the individual transactions through the internet at the database of the processing station wherein
the legacy indications and the individual indications are for an airplane flight on a particular date between a particular originating location and a particular destination and wherein
the legacy indications are provided by a global distribution system representing several of the primary airlines and wherein
the individual indications are provided by other airlines than the primary airlines.

50. In a method as set forth in claim 46, including the steps of:
receiving the indications of the legacy transactions through a wide area network at the database of the processing station,
receiving the indications of the individual transactions through the internet at the database of the processing station wherein
the legacy indications and the individual indications are for an airplane flight on a particular date between a particular originating location and a particular destination and wherein
the indications of the legacy flights are provided by a global distribution system representing several of the primary airlines and the legacy indications are provided for airline flights at established and published prices and wherein
the individual indications are provided by the airlines in the global distribution system for the airline flights at prices discounted from the established and published prices.

51. In a method as set forth in claim 46, including the steps of:
receiving the indications of the legacy transactions through a wide area network at the database of the processing station,
receiving the indications of the individual transactions through the Internet at the database of the processing station wherein
the legacy indications and the individual indications are for an airplane flight on a particular date between a particular originating location and a particular destination and wherein
the indications of the legacy flights are provided by a global distribution system representing several of the primary airlines and the legacy indications are provided for airline flights at established and published prices and wherein
the individual indications are provided by consolidators who purchase blocks of airline tickets at prices discounted from the established and published prices and offer these tickets to the public at prices which are between the established and published prices and the discounted prices.

52. A method of billing at a processing station for a particular transaction, including the steps of:
providing, in a gateway at a processing station, indications of a plurality of transactions each capable of being used as the particular transaction,
providing for a selection in a database at the processing station of a specific one of the transactions in the plurality as the particular transaction, the specific one of the transactions being obtained from an issuer displaced from the processing station and providing for the performance of the specific one of the transactions, and
providing in the database at the processing station for a printing of the selected one of the transactions by a printer selected from a group consisting of (a) a printer at the processing station and (b) a printer at the premises of the issuer of the selected one of the transactions.

53. In a method as set forth in claim 54 wherein
some of the transactions in the plurality are legacy transactions provided through a wide area network to the gateway at the processing station and others of the transactions in the plurality are provided to the gateway in the processing station through the internet.

54. In a method as set forth in claim 54 wherein
the indication of one of the transactions in the plurality is provided to the printer at the processing station through a local area network when the printer at the processing center is selected by the database and wherein
the indication of the specific one of the transactions in the printer as the transaction is provided at the premises of the issuer through the local area network, a gateway at the processing station and a wide area network when the printer at the premises of the issuer is selected by the database.

55. A method as set forth in claim 54 wherein
the transactions in the plurality are airline flights on a particular day between a particular originating location and a particular destination and wherein
some of the airline flights in the plurality are provided by a legacy server which represents some of the primary airlines and which quotes established and published prices and wherein others of the airline flights in the plurality are provided by airlines other than the primary airlines in the legacy server or are provided by the primary airlines offering prices discounted from the established and published prices.

56. In a method as set forth in claim 55 wherein
the indication of one of the transactions in the plurality is provided to the printer at the processing station as the particular transaction through a local area network when the printer at the processing center is selected by the database and wherein
the indication of the specific one of the transactions in the printer at the specific one of the transactions is provided at the premises of the issuer through the local area network, a gateway at the processing station and a wide area network when the printer at the premises of the issuer is selected by the database and wherein
the transactions in the plurality are airline flights on a particular day between a particular originating location and a particular destination and wherein
some of the airline flights in the plurality are provided by a legacy server representing some of the primary airlines and which quote established and published prices and wherein others of the airline flights in the plurality are provided by airlines other than the primary airlines in the legacy server or are provided by the primary airlines offering prices discounted from the established and published prices.

57. An article of manufacture comprising:
at least one computer readable medium having computer readable program code embodied jointly or severally thereon for causing a plurality of computers to perform the acts of:
a. providing a human interface;
b. inputting via the human interface, a request for details of travel services, the request being in a format intelligible to a GDS;
c. sending a first copy of the request to the GDS;
d. sending, through Internet, a second copy of the request to a server computer;
e. receiving, from the GDS, a first details of travel services;
f. receiving, via Internet, from the server computer, a second details of travel services, the second details of travel services having been received by the server computer in response to at least one web response received by the server computer in response to a web request, from the server computer, to a web site, wherein the web request is composed responsive to a data content of the request for services; and
g. outputting, via the human interface, a representation of the first and the second details of travel services.

58. A computer system for presenting travel industry services comprising:
a client computer; and
a server computer communicating with the client computer using Internet;
wherein the server computer and the client computer cooperatively exchange data and execute instructions for:
a. providing a human interface;
b. inputting via the human interface, a request for details of travel services, the request being in a format intelligible to a GDS;
c. sending a first copy of the request to the GDS;
d. sending, through Internet, a second copy of the request to a server computer;
e. receiving, from the GDS, a first details of travel services;
f. receiving, via Internet, from the server computer, a second details of travel services, the second details of travels services having been received by the server computer in response to at least one web response received by the server computer in response to a web request, from the server computer, to a web site, wherein the web request is composed responsive to a data content of the request for services; and
g. outputting, via the human interface, a representation of the first and the second details of travel services.
